(19) United States
(12) Patent Application Publication
(10) Pub. No.: US 2023/0000018 A1
(43) Pub. Date: Jan. 5, 2023

(54) AUTOMATED HEMP PLANT WINDROWER MACHINERY AND APPARATUSES, METHODS RELATING TO SAME

(71) Applicant: Rocky Ford Harvesting, LLC, Rocky Ford, CO (US)

(72) Inventors: Joel LUNDQUIST, Rocky Ford, CO (US); Ryan WAINER, Rocky Ford, CO (US)

(21) Appl. No.: 17/856,840

(22) Filed: Jul. 1, 2022

Related U.S. Application Data
(60) Provisional application No. 63/217,582, filed on Jul. 1, 2021.

(51) Int. Cl. A01D 45/06; A01D 57/12; A01D 57/30

(52) U.S. Cl. CPC A01D 45/065; A01D 57/12; A01D 57/30

(57) ABSTRACT

In some embodiments, a system includes a housing, a cutting assembly, a tine assembly, and an auger. The cutting assembly includes a plurality of axially-aligned cutting portions and a plurality of projections extending distally relative to the plurality of cutting portions and configured to urge a non-stalk portion of a plant vertically upward relative to a stalk portion of the plant. Adjacent projections of the plurality of projections extending distally from opposite sides of each cutting portion define a receiving space aligned with each cutting portion within which the stalk of a plant can be received to be cut by the cutting portion into a first plant portion and a second plant portion. The tine assembly can be rotated to urge the first plant portion into the interior space of the housing; and an auger can urge the first plant portion toward and through a rear opening.

### CROSS-REFERENCE TO RELATED APPLICATIONS

This application claims priority to U.S. Provisional Patent Application No. 63/217,582, entitled “Automated Hemp Plant Windrower Machinery and Apparatuses, Methods Relating to Same,” filed on Jul. 1, 2021, the disclosure of which is incorporated by reference herein in its entirety.

### BACKGROUND

The demand for cannabis-based products has been increasing in recent years. For example, cannabidiol (CBD) oil is a natural, non-psychoactive concentrate that can be extracted from the stalks and seeds of cannabis plants such as hemp. Additionally, cannabis plants produce flowers that can be consumed for medical and recreational purposes.

Thus, there is a need for systems and methods of increasing the efficiency of forming plant windrows (e.g., rows of cannabis plants).

### SUMMARY

In some embodiments, a system includes a housing, a cutting assembly, a tine assembly, and an auger. The housing defines an interior space and at least one rear opening. The cutting assembly includes a plurality of axially-aligned cutting portions and a plurality of projections extending distally relative to the plurality of cutting portions and configured to urge a non-stalk portion of a plant vertically upward relative to a stalk portion of the plant. Each cutting portion can be separated from an adjacent cutting portion by at least one projection of the plurality of projections. Adjacent projections of the plurality of projections can extend distally from opposite sides of each cutting portion defining a receiving space aligned with each cutting portion within which the stalk of a plant can be received to contact the respective cutting portion and be cut by the cutting portion into a first plant portion and a second plant portion. The tine assembly can be configured to be rotated to urge the first plant portion into the interior space of the housing. The auger can be disposed within the interior space and configured to urge the first plant portion toward and through the at least one rear opening.

### BRIEF DESCRIPTION OF THE DRAWINGS

FIG. 1 is a schematic block diagram of a system, according to an embodiment.

FIG. 2 is a flow chart of a method, according to an embodiment.

FIG. 3 is a flow chart of a method, according to an embodiment.

FIG. 4 is a perspective view of a system, according to an embodiment.

FIG. 5 is a perspective view of a portion of the system of FIG. 4 mounted to a vehicle.

FIG. 6 is a top view of a portion of the system of FIG. 4.

FIG. 7 is a perspective view of a front portion of the system of FIG. 4.

FIG. 8 is a back view of the system of FIG. 4.

FIG. 9 is a schematic illustration of a portion of a cutting assembly, according to an embodiment.

FIG. 10 is a schematic illustration of a portion of a cutting assembly, according to an embodiment.

FIG. 11 is a schematic illustration of a system coupled to a vehicle and configured to be mechanically driven, according to an embodiment.

FIG. 12 is a schematic illustration of a cross-section of a cutting portion, according to an embodiment.

### DETAILED DESCRIPTION

In some embodiments, a system includes a housing, a cutting assembly, a tine assembly, and an auger. The housing defines an interior space and at least one rear opening. The cutting assembly includes a plurality of axially-aligned cutting portions and a plurality of projections extending distally relative to the plurality of cutting portions and configured to urge a non-stalk portion of a plant (e.g., one or more leaves) vertically upward relative to a stalk portion of the plant. Each cutting portion can be separated from an adjacent cutting portion by at least one projection of the plurality of projections. Adjacent projections of the plurality of projections can extend distally from opposite sides of each cutting portion defining a receiving space aligned with each cutting portion within which the stalk of a plant can be received to contact the respective cutting portion and be cut by the cutting portion into a first plant portion and a second plant portion. The tine assembly can be configured to be rotated to urge the first plant portion into the interior space of the housing. The auger can be disposed within the interior space and configured to urge the first plant portion toward and through the at least one rear opening.

In some embodiments, a method includes advancing a housing such that a base of a stalk of a plant is received in a receiving space defined between a first projection and a second projection extending from a front of the housing and such that at least one of the first projection or the second projection urges a non-stalk portion of the plant vertically upward away from the base of the stalk (e.g., away from an intended cutting location at the base of the stalk). The method further includes further advancing the housing (i.e., toward the plant) such that cutting blades disposed between the first projection and the second projection sever the base of the stalk at the cutting location such that the plant is divided into a first plant portion and a second plant portion and the first plant portion is pulled into an interior of the housing by a tine assembly disposed at least partially within the housing and urged toward a rear opening of the housing by an auger such that the first plant portion is deposited behind the housing via the rear opening as the housing is advanced.

In some embodiments, a method includes receiving a base of a stalk of a plant into a receiving space defined between a first projection and a second projection such that at least one of the first projection or the second projection urges a non-stalk portion of the plant upward away from the base of the stalk to expose a cutting location of the base of the stalk. The base of the stalk can be severed into a first plant portion and a second plant portion at the cutting location using one or more cutting blades disposed proximally of the receiving space (e.g., between the first projection and the second projection). The first plant portion can be moved (e.g., pulled or urged) into an interior space of the housing using a tine assembly disposed at least partially within the housing. The first plant portion can be urged toward a rear opening of the housing using an auger such that the first plant portion exits the housing via the rear opening.

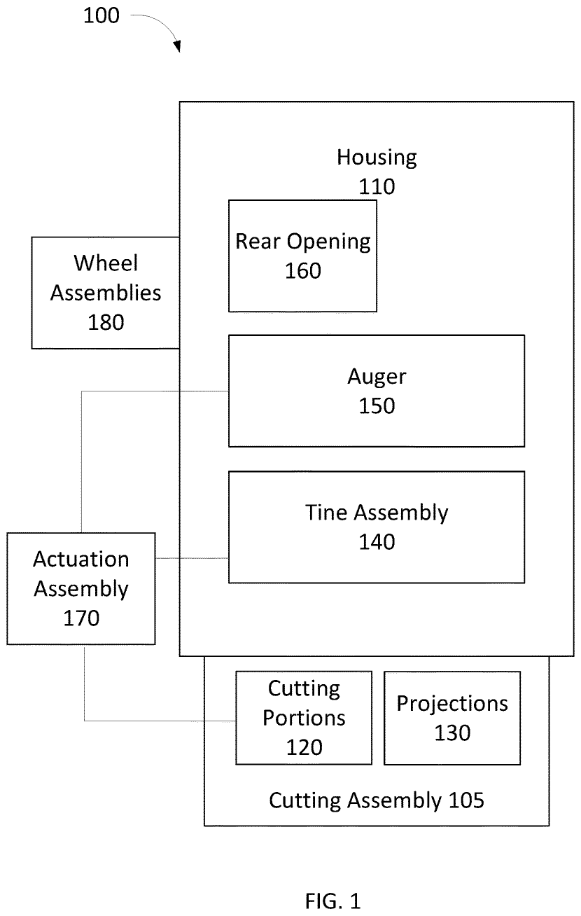

In some embodiments, a system 100 includes a housing or frame 110, a cutting assembly 105, a tine assembly 140, and an auger 150. The cutting assembly 105 includes one or more cutting portions 120 and two or more projections 130. The system 100 also includes or is couplable to an actuation assembly 170 and one or more wheel assemblies 180. The actuation assembly 170 can be operably coupled to the tine assembly 140 and the auger 150 to control (e.g., simultaneously) rotation of the tine assembly 140 and the auger 150. As shown in FIG. 1, the actuation assembly 170 can also be operably coupled to the cutting portions 120 such that the actuation assembly 170 can control a cutting motion (e.g., a rotational movement or lateral axial movement) of cutting blades included at least partially within the cutting portions 120.

The housing 110 can define an interior space within which the auger 150 is disposed. In some embodiments, at least a portion of the tine assembly 140 can also be disposed within the interior space defined by the housing 110. The housing 110 can include a bottom wall, opposing sidewalls extending upward from each end of the bottom wall, and a back wall extending upward from a back edge of the bottom wall. The back wall, the bottom wall, and/or a combination of the back wall and the bottom wall can define at least one rear opening 160. In some embodiments, the housing 110 can include a top wall portion (e.g., defining an upper boundary of the interior space). In some embodiments, the housing 110 can include a curved wall portion coupling the back wall to the bottom wall, and the curved wall portion can define a portion of the rear opening 160 (e.g., in combination with the back wall and/or the bottom wall).

Each wheel assembly 180 can include mounting hardware and at least one wheel. The wheel assemblies 180 can be mounted to the housing 110 such that the system 100 can be supported at least in part by the wheel assemblies 180 and can be translated (e.g., advanced forward relative to the ground and/or one or more rows of plants) via rotation of the wheels of the wheel assemblies 180. In some embodiments, the system 100 can include two wheel assemblies 180 (e.g., each coupled to opposing sides of the housing 110). The system 100 (e.g., the housing 110) can also be mounted to a vehicle such as a tractor (e.g., a loader) such that the system 100 is partially supported by the wheel assemblies 180 and partially supported by and translatable via rotation of the wheels of the wheel assemblies 180 under the power of the vehicle.

Each of the one or more cutting portions 120 can be disposed near or adjacent to a bottom front portion of the housing 110 (e.g., near or adjacent to a front edge of the bottom wall of the housing 110). Each of the one or more cutting portions 120 can be operable to sever a plant at a cutting location (e.g., at a base of a stalk) into a first plant portion and a second plant portion as the system 100 is advanced (e.g., translated forward) relative to (i.e., towards) the plant. The first plant portion can include, for example, flowers, leaves, and at least a portion of a stalk of the plant. The second plant portion can include, for example, roots and any portion of the stalk of the plant disposed below the cutting location. The second plant portion can remain rooted in the ground after the plant is severed at the cutting location. The plant can be, for example, hemp plants.

In some embodiments, the system 100 can include one, two, three, four, or more sets of cutting portions 120. The cutting portions 120 can be axially-aligned and spaced apart along an axis disposed perpendicular to the direction of travel of the system 100. In some embodiments, each cutting portion 120 can each include at least a portion of at least one cutting blade. In some embodiments, each cutting portion 120 can be an exposed portion of a cutting blade assembly that extends along the axis and has alternating exposed and unexposed portions such that only the exposed portions can contact plants. Thus, in some embodiments, each cutting portion 120 can include a portion of one or more cutting blades that may also be included in other cutting portions 120. In some embodiments, each cutting portion 120 can include one or more cutting blades distinct from the cutting blades in other cutting portions 120.

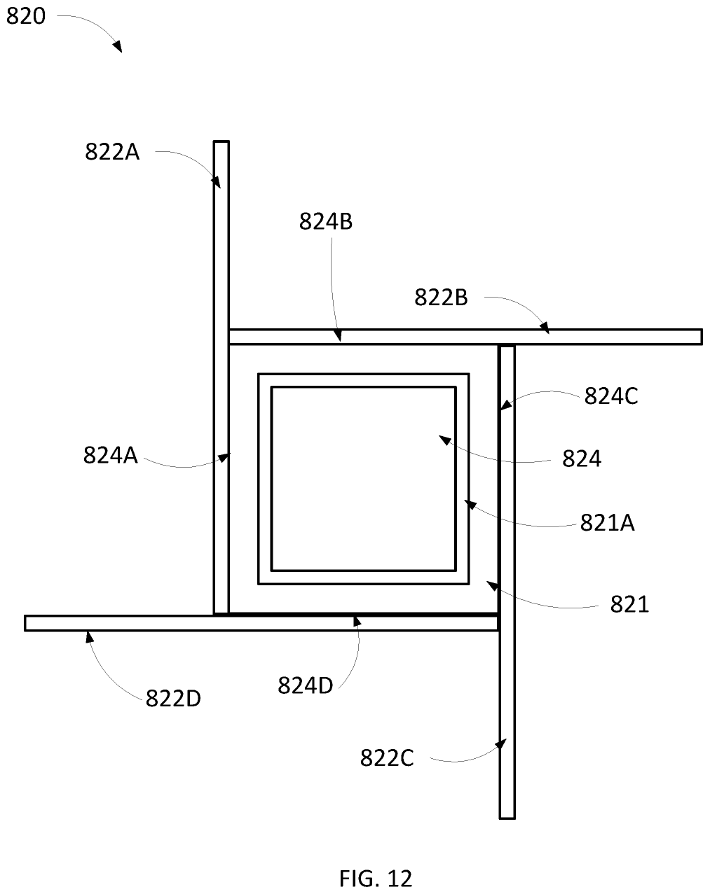

In some embodiments, each of the one or more cutting portions 120 can include a set of cutting blades. In some embodiments, each set of cutting blades can be rotatable about a central axis. The central axis of each set of cutting blades can be coaxial with each central axis of the remaining sets of cutting blades. The cutting blades of each set of cutting blades can be rotated to serially contact and cut the plant at the cutting location to sever the first plant portion from the second plant portion of the plant. In some embodiments, each set of cutting blades can include one, two, three, four, or more cutting blades coupled to (e.g., affixed to) and extending from a central axle. In some embodiments, each set of cutting blades can be coupled to (e.g., affixed to) and extend from a central rotatable bar such that rotation of the rotatable bar causes simultaneous rotation of each cutting blade of each set of cutting blades about a central axis of the central rotatable bar. The central rotatable bar can include discrete axle portions to which the cutting blades are attached formed as a unitary structure with connecting portions. In some embodiments, the central rotatable bar to which the cutting blades are coupled can be partially enclosed within a bar housing and/or by projections 130. The bar housing can define openings within which the sets of cutting blades are disposed to expose the cutting blades such that the cutting blades can extend through the openings in the bar housing to cut plants and/or plants can be received within the openings and into contact with the cutting blades. The central rotatable bar can be rotated such that the cutting blades cut upward when rotated into contact with a plant (i.e., an upwardly directed cutting motion). Additionally, the cutting portions 120 can include a tubular member to which the cutting blades are coupled (e.g., mounted). The tubular member can define a passageway or lumen having a cross-sectional shape and size configured to receive and mate with the central rotatable bar such that rotation of the central rotatable bar causes rotation of the tubular member. For example, each can have a square, rectangular, or triangular cross sectional shape. Thus, the tubular member can be coupled to the central rotatable bar by sliding the tubular member along the central rotatable bar to the desired location and mounting the tubular member in place. If needed, such as due to a broken cutting blade, the tubular member can be decoupled via sliding the tubular member off of the central rotatable bar (after uncoupling any lateral securing mechanisms such as bolts and/or bearings). In some embodiments, the tubular member has a square-shaped outer cross-sectional area, with each of four cutting blades extending from a different outer surface of the tubular (e.g., in a direction perpendicular to adjoining surfaces and parallel to the surface to which the cutting blade is coupled). For example, FIG. 12 is a schematic illustration of a cross-section of a cutting portion 820 including a tubular member 821 defining a central passageway or lumen 821A having a square-shaped cross-section, a central rotatable bar 824 disposed within the passageway 821A, and four cutting blades 822A, 822B, 822C, and 822D coupled (e.g., welded) to the tubular member 821. As shown, the first cutting blade 822A can be coupled to a first surface 824A of the tubular member 821 and can have a free end extending away from the tubular member 821 and the central rotatable bar 824 in a direction parallel to a plane including the first surface 824A and perpendicular to the second surface 824B of the tubular member 821, which is perpendicular to the first surface 824A. The second cutting blade 822B is coupled to the second surface 824B of the tubular member 821, the third cutting blade 822C is coupled to the third surface 824C of the tubular member 821, and the fourth cutting blade 822D is coupled to the fourth surface 824D of the tubular member 821 similarly to the manner in which the first cutting blade 822A is coupled to the first surface 824A. The cutting blades 822 can extend away from the central rotatable bar 824 any suitable distance. In some embodiments, the central rotatable bar 824 can be rotated clockwise for cutting.

In some embodiments, each of the one or more cutting portions 120 can include a set of cutting blades extending distally from a longitudinally-extending bar along an axis. The bar (also referred to as a cutter bar) can be moved laterally along the axis back and forth such that the cutting blades (also referred to as teeth or mowing fingers) also move back and forth and can cut plants that contact the cutting blades. In some embodiments, the cutting blades can move back and forth relative to one or more stationary sickle guards (e.g., a sickle guard can be disposed between each blade in an initial configuration of the cutting assembly 105) and/or other cutting blades in the set. In some embodiments, the cutting blades can be shaped as triangular distally-extending teeth. In some embodiments, rather than having cutting blades evenly spaced and extending distally from the longitudinally-extending bar, the longitudinally-extending bar can include discrete portions (associated with the cutting portions 120) to which the cutting blades are attached (that may be the same as or larger in length than exposed portions 120 of the longitudinally-extending bar that are exposed for contact with a plant) and may be formed as a unitary structure with connecting portions. In some embodiments, the longitudinally-extending bar to which the cutting blades are coupled can be partially enclosed within a bar housing and/or by projections 130. The bar housing can define openings within which at least a portion of the sets of cutting blades are disposed during operation of the cutting assembly 105 to expose the cutting blades such that the cutting blades can extend through the openings in the bar housing to cut plants and/or plants can be received within the openings and into contact with the cutting blades.

Each cutting portion 120 can be separated from an adjacent cutting portion by at least one projection 130. The projections 130 can also be referred to as “crop lifters.” Adjacent projections 130 extending distally from opposite sides of each cutting portion 120 can define a receiving space aligned with each cutting portion 120 within which the stalk of a plant can be received to contact the respective cutting portion 120 and be cut by the cutting portion 120 into a first plant portion and a second plant portion. In some embodiments, the projections 130 can include a set (e.g., a pair) of projections 130 associated with each cutting portion 120. For example, each projection 130 of a pair of projections can be arranged adjacent to a cutting portion 120 such that a first projection 130 extends from a first side of the cutting portion 120 (e.g., from a first end of an axle of a set of cutting blades of the cutting portion 120, a location near a first end of a set of cutting blades of the cutting portion 120, or a location at or near a first end of a cutting portion 120 defined by an opening in a bar housing) and a second projection extends from a second side of the cutting portion (e.g., from a second end of the axle of the set of cutting blades of the cutting portion 120, a location near a second end of the set of cutting blades of the cutting portion 120, or a location at or near a second end of the cutting portion 120 defined by the opening in the bar housing opposite the first end). Each projection 130 extends distally (e.g., forward) relative to the cutting portions 120 (e.g., the cutting blades) such that the projections can contact a plant and lift portions of the first plant portion (e.g., leaves, stems, and/or branches) of the plant away from the cutting location of the stalk (e.g., vertically upward) to expose the cutting location prior to the plant being received by a cutting portion 120. For example, each projection 130 can be coupled (e.g., mounted) to the bar housing enclosing the central rotatable bar or longitudinally-extending bar described above to which cutting blades are coupled. Each projection 130 can taper away from the housing 110 and the cutting portion 120. For example, each projection 130 can include an upper surface (e.g., a first plant portion contacting surface) that is tapered downward such that more distal portions of the upper surface are vertically lower than more proximal portions of the upper surface.

In some embodiments, each projection 130 can be formed as a tapered plate that extends distally relative to the cutting portions 120. In some embodiments, one or more projections 130 can extends laterally the entire distance between adjacent cutting portions 120, and one or more projections can extend laterally away from the outermost axially disposed cutting portions 120 (e.g., as end projections disposed between a cutting portion 120 and an end of the housing 110 and/or the system 100). Thus, rather than each cutting portion 120 being associated with a discrete pair of projections 130, adjacent cutting portions 120 can share one common tapered plate projection 130. Thus, rather than a discrete pair of projections 130 defining the lateral boundaries of each receiving space aligned with each cutting portion 120, in some embodiments, a first projection 130 and a second projection 130 can defined the boundaries of a first receiving space aligned with a first cutting portion 120, and the second projection 130 and a third projection 130 can define the boundaries of a second receiving space aligned with a second cutting portion 120. The tapered plate projection 130 can include an upper surface (e.g., a first plant portion contacting surface) that is tapered downward such that more distal portions of the upper surface are vertically lower than more proximal portions of the upper surface. The upper surface can be planar or rounded.

In some embodiments, each cutting portion 120 can be disposed a distance from an adjacent cutting portion 120 such that each cutting portion 120 can be simultaneously aligned with a respective row of plants. The rows can be arranged in parallel relative to one another and a plant from each row can be simultaneously contacted and severed by a cutting portion 120 aligned with that respective row. The system 100 can include any suitable number of cutting portions. For example, in some embodiments, the system 100 can include one, two, three, four or more sets of cutting portions 120.

The tine assembly 140 (also referred to as a reel or a pickup reel) includes at least one set of tines (also referred to as teeth) configured to be rotated about a central axis to urge plant material (e.g., a first portion of a plant cut by the cutting portions 120) into an interior of the housing 110 and toward the auger 150. In some embodiments, each set of tines can be arranged in a row (e.g., along a “bat”) extending from a first end to a second end of an interior of the housing 110 and disposed parallel to the remaining sets of tines. In some embodiments, each set of tines can be coupled to a central rotatable bar (e.g., via a connecting bar and/or plate) and disposed equidistant from the central rotatable bar such that rotation of the central rotatable bar causes rotation of each set of tines around the central axis of the central rotatable bar. In some embodiments, each tine in each set of tines can extend away from the central axis at any suitable angle.

The auger 150 can be used to urge plant material (e.g., a first portion of a plant cut by the cutting portions 120) disposed within the interior of the housing 110 toward and through one or more rear openings 160 defined by the housing 110. In some embodiments, each of the one or more rear openings 160 are disposed a distance relative to an adjacent rear opening 160 such that, as the system 100 is advanced forward relative to the rows of plants, the first plant portions cut by the sets of cutting portions 120 are urged and/or fall from the rear openings 160 to form rows of first plant portions (i.e., windrows). In some embodiments, each rear opening 160 can be disposed in alignment with a cutting portion 120 such that the rows of plants that are disposed ahead of and are aligned with the cutting portions 120 are also aligned with the rows of cut first plant portions formed behind the system 100 as the system 100 advances (i.e., by the system 100 cutting the first plant portions from the second plant portions and moving the first plant portions through the system 100 and out of the rear openings 160). Thus, in some embodiments, there are equal numbers of cutting portions 120 and rear openings 160. In some embodiments, the center of each rear opening 160 is aligned with a center of a cutting portion 120. In some embodiments, the center of each rear opening 160 is spaced from the center of an adjacent rear opening 160 (e.g., the next closest rear opening in a series of two or more rear openings 160) the same distance as the distance between the centers of adjacent cutting portions 120 and/or the distance between the center of beds within which rows of plants are planted from which the system 100 is intended to be harvesting plants simultaneously (e.g., about 60 inches or about 30 inches). In some embodiments, each rear opening 160 has a width in a plane parallel to the ground that is less than the axially-spaced distance between center points or end points of adjacent cutting portions 120. In some embodiments, the housing 110 defines only one rear opening 160 such that all plant portions that enter the housing 110 exit via the one rear opening 160 and form one row of plant portions behind the system 100. In some embodiments, the rear opening 160 can be centered along the back and/or bottom of the housing 110.

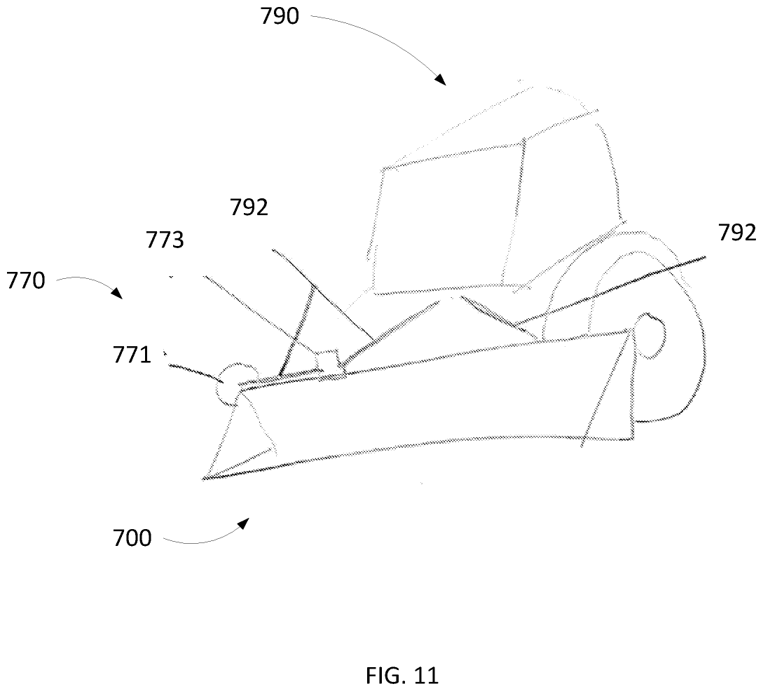

As disclosed above, the actuation assembly 170 can be operably coupled to each of the auger 150, the tine assembly 140, and the one or more sets of cutting portions 120. For example, the actuation assembly 170 can be coupled to the auger 150, the central rotatable bar of the tine assembly 140, and the central rotatable bar or longitudinally-extending bar to which the cutting blade(s) of the cutting portions 120 are coupled such that the actuation assembly 170 can simultaneously rotate the auger 150 and the tine assembly 140 and move the cutting portions 120 in a cutting movement (e.g., rotationally or laterally). In some embodiments, the actuator assembly 170 can be operatively coupled to the auger 150, the central rotatable bar of the tine assembly 140, and the central rotatable bar or longitudinally-extending bar associated with the cutting portions 120 to via one or more wheels and pulleys. In some embodiments, the actuation assembly 170 can include a motor assembly. The motor assembly 170 can be, for example, a hydraulic motor and can be powered and controlled via the vehicle to which the system 100 is coupled. For example, the system 100 can include hoses (e.g., hydraulic hoses) configured to couple the motor of the system 100 to a hydraulic actuator of the vehicle such that an interface of the vehicle can be used to control the actuation and/or direction of rotation of the auger 150, the tine assembly 140, and the cutting blades 120. In some embodiments, the actuation assembly 170 can be mechanically driven. For example, one or more pulleys operably coupled to the cutting assembly 105, the auger 150, and the tine assembly 140 can be coupled to one or more power take-off (PTO) shafts of the vehicle via a gear box so that mechanical power can be transferred from the vehicle to the pulleys to drive rotation of the auger 150 and the tine assembly 140 and to drive rotational and/or lateral cutting motion of the cutting portions 120. For example, FIG. 11 is a schematic illustration of a system 700, which can be the same or similar as any of the systems described herein such as the system 100, coupled to a vehicle 790 via a mechanical actuator 770 including a pulley assembly 771, a gear box 773, and at least one PTO shaft 792 and configured to be mechanically driven via the PTO shaft(s).

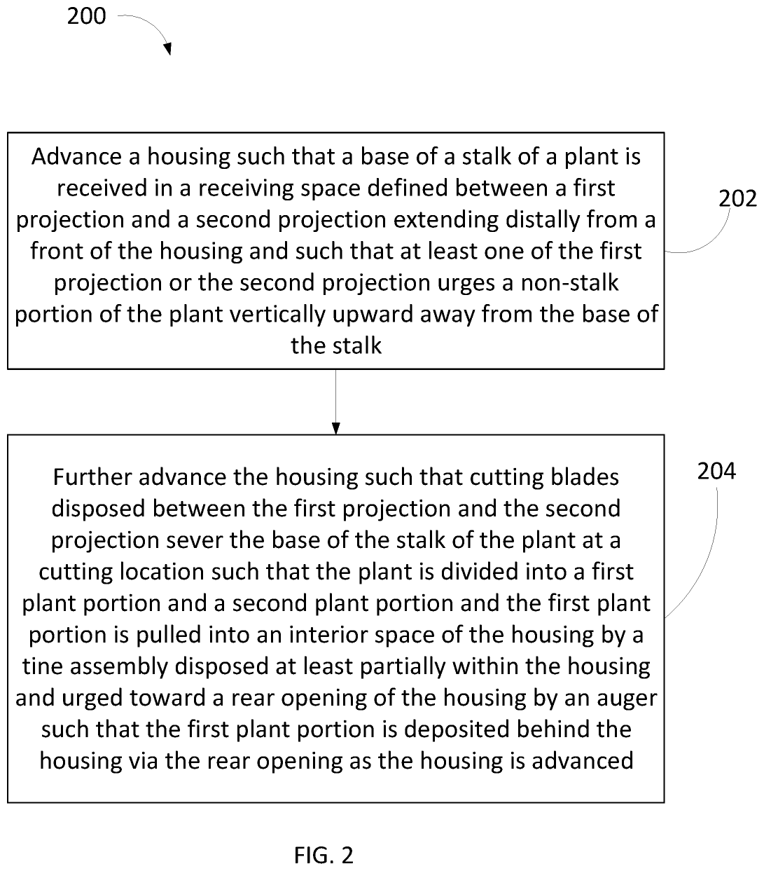

FIG. 2 shows a flowchart of a method 200 of using a system, such as any of the systems described herein (e.g., the system 100). As shown in FIG. 2, the method 200 includes advancing, at 202, a housing such that a base of a stalk of a plant is received in a receiving space defined between a first projection and a second projection extending from a front of the housing and such that at least one of the first projection or the second projection urges a non-stalk portion of the plant vertically upward away from the base of the stalk (e.g., away from an intended cutting location at the base of the stalk). The method 200 further includes further advancing, at 204, the housing (i.e., toward the plant) such that cutting blades disposed between the first projection and the second projection sever the base of the stalk at the cutting location such that the plant is divided into a first plant portion and a second plant portion and the first plant portion is pulled into an interior of the housing by a tine assembly disposed at least partially within the housing and urged toward a rear opening of the housing by an auger such that the first plant portion is deposited behind the housing via the rear opening as the housing is advanced. In some embodiments, as described above with respect to the system 100, the method 200 can include advancing a housing having multiple cutting portions and a set of first and second projections associated with each cutting portion to simultaneously urge a non-stalk portion of a plurality of plants away from the respective base of each stalk. In some embodiments, as described above with respect to the system 100, the method 200 can include advancing a housing having multiple cutting portions and a projection disposed between each adjacent cutting portion (e.g., extending the distance between each cutting portion) and disposed on each side of each cutting portion to simultaneously urge a non-stalk portion of a plurality of plants away from the respective base of each stalk and to simultaneously sever a plurality of plant stalks at each plant stalks cutting location. A first plant portion of each plant can then be pulled into an interior space of the housing and urged toward one or more rear openings of the housing as the housing is advanced. In some embodiments, the steps of the method 200 can be performed simultaneously with reference to different plants in a row such that as a closer-disposed plant having previously been received in a receiving space is being severed by cutting blades, the next plant in the row is being received in the receiving space, and previously severed plants may be being moved through the interior space and out of the rear opening.

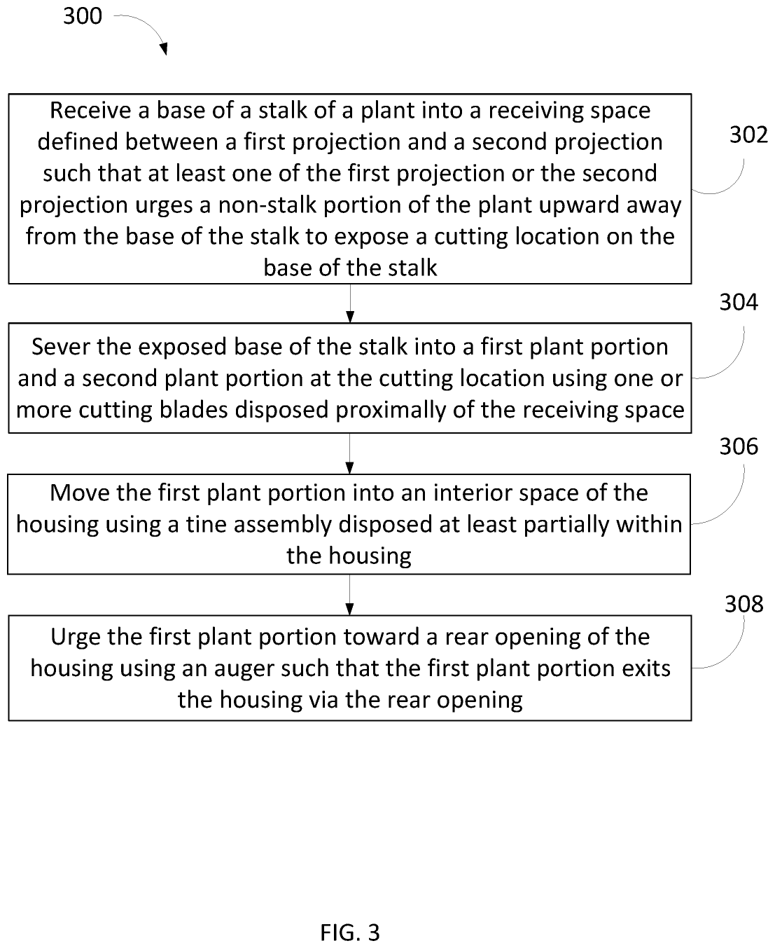

FIG. 3 shows a flowchart of a method 300 performed using a system, such as any of the systems described herein (e.g., the system 100). As shown in FIG. 3, the method 300 includes receiving, at 302, a base of a stalk of a plant into a receiving space defined between a first projection and a second projection such that at least one of the first projection or the second projection urges a non-stalk portion of the plant upward away from the base of the stalk to expose a cutting location of the base of the stalk. The base of the stalk can be severed into a first plant portion and a second plant portion at the cutting location, at 304, using one or more cutting blades disposed proximally of the receiving space (e.g., between the first projection and the second projection). The first plant portion can be moved, at 306, (e.g., pulled or urged) into an interior space of the housing using a tine assembly disposed at least partially within the housing. The first plant portion can be urged, at 308, toward a rear opening of the housing using an auger such that the first plant portion exits the housing via the rear opening.

In some embodiments, multiple or all of the steps of the method 300 can be simultaneously performed on different plants and/or plant portions. For example, in some embodiments, the method 300 can include simultaneously receiving a base of a second plant into a second receiving space defined between the second projection and a third projection such that at least one of the second projection or the third projection urges a non-stalk portion of the second plant upward away from the base of the stalk to expose a cutting location on the base of the stalk of the second plant. The exposed base of the stalk of the second plant can be severed into a first plant portion and a second plant portion at the cutting location using one or more cutting blades disposed proximally of the second receiving space. The first plant portion of the second plant can be moved into an interior of the housing using the tine assembly. The first plant portion of the second plant can be urged toward a second rear opening of the housing using the auger such that the first plant portion of the second plant exits the housing via the second rear opening. In some embodiments, the first rear opening can be aligned with at least one of the first receiving space or the second receiving space, and the first plant portion of the first plant can be urged toward the first rear opening of the housing using the auger such that the first plant portion of the first plant exits the housing via the first rear opening to form a portion of a windrow aligned with the first receiving space or the second receiving space

In some embodiments, the method 300 can include simultaneously receiving a base of a second plant into a second receiving space defined between a third projection and a fourth projection such that at least one of the third projection or the fourth projection urges a non-stalk portion of the second plant upward away from the base of the stalk to expose a cutting location on the base of the stalk of the second plant. The exposed base of the stalk of the second plant can be severed into a first plant portion and a second plant portion at the cutting location using one or more cutting blades disposed proximally of the second receiving space. The first plant portion of the second plant can be moved into an interior of the housing using the tine assembly. The first plant portion of the second plant can be urged toward a second rear opening of the housing using the auger such that the first plant portion of the second plant exits the housing via the second rear opening. In some embodiments, the first rear opening can be aligned with at least one of the first receiving space or the second receiving space, and the first plant portion of the first plant can be urged toward the first rear opening of the housing using the auger such that the first plant portion of the first plant exits the housing via the first rear opening to form a portion of a windrow aligned with the first receiving space or the second receiving space.

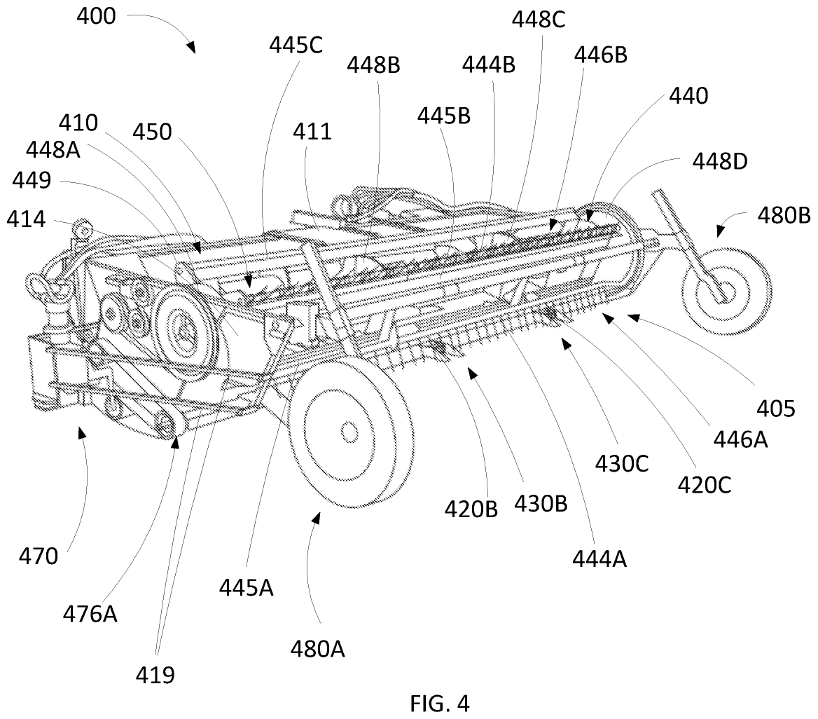

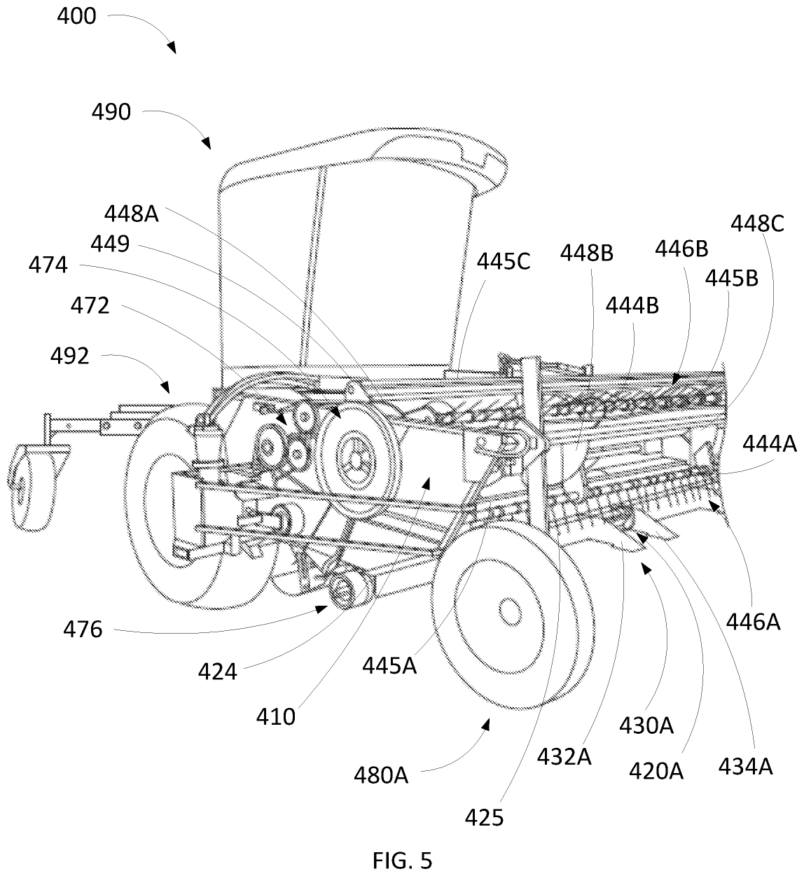

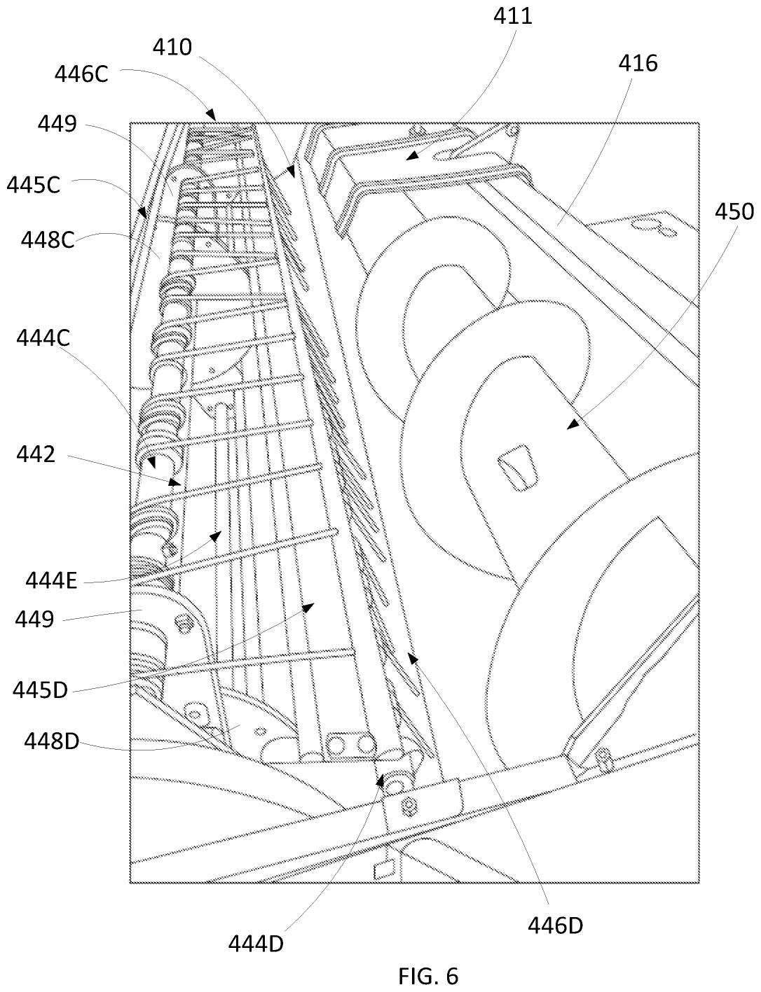

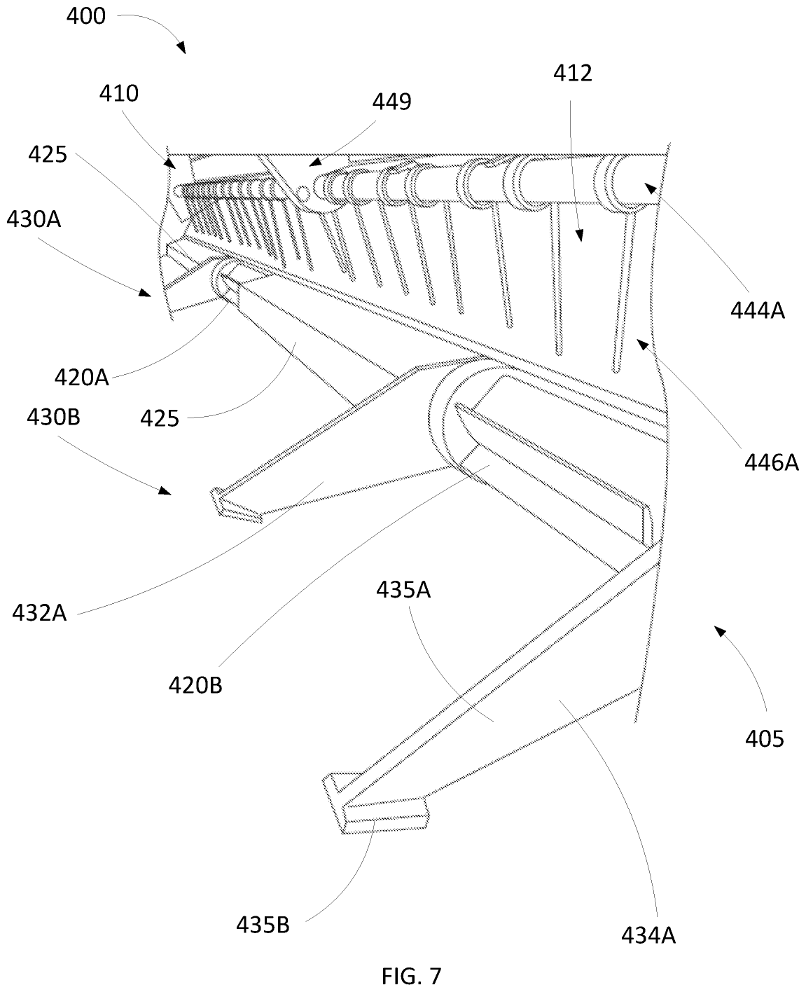

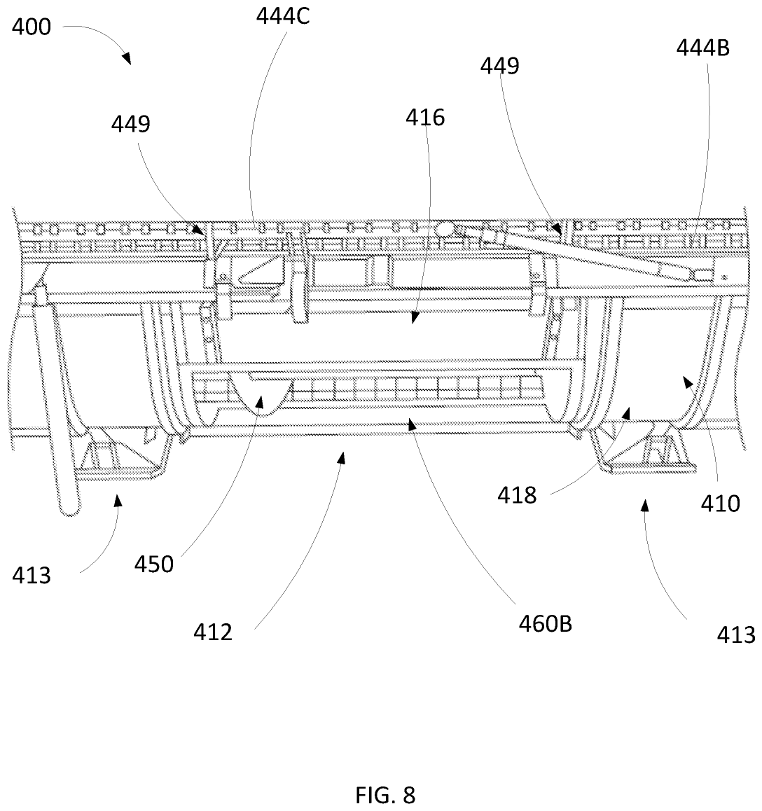

FIG. 4 is a perspective view of a system 400. FIG. 5 is a perspective view of a portion of the system 400 mounted to a vehicle 490. FIG. 6 is a top view of a portion of the system 400. FIG. 7 is a perspective view of a front portion of the system 400. FIG. 8 is a back view of the system 400. The system 400 can be the same or similar in structure and/or function to any of the systems described herein, such as the system 100. For example, the system 400 includes a housing 410, a cutting assembly 405, a tine assembly 440, and an auger 450. The cutting assembly 405 includes cutting portions including one or more sets of cutting blades 420 (e.g., a first set 420A shown in FIG. 5, a second set 420B, and a third set 420C) and one or more sets of projections 430 (e.g., a first set 430A shown in FIG. 5, a second set 430B, and a third set 430C). The system 400 also includes a motor assembly 470, a first wheel assembly 480A, and a second wheel assembly 480B. The motor assembly 470 is operably coupled to the tine assembly 440 and the auger 450 to control rotation of the tine assembly 440 and the auger 450. The motor assembly 470 is also operably coupled to the cutting assembly 405 such that the motor assembly 470 can control a cutting motion (e.g., a rotation) of the sets of cutting blades 420A, 420B, and 420C.

The housing 410 can define an interior within which the auger 450 and at least a portion of the tine assembly 440 can be disposed. The housing 410 can include a bottom wall 412, opposing sidewalls 414 extending upward from each end of the bottom wall, and a back wall 416 extending upward from a back edge of the bottom wall. As shown in FIG. 8, the housing 410 includes a curved portion 418 coupling the back wall 416 to the bottom wall 412, and the curved portion 418 can define a portion of the rear openings 460 (e.g., in combination with the back wall 416 and/or the bottom wall 412). In some embodiments, as shown in FIG. 6, the housing 410 can include a top wall portion 411 disposed at least above the rear opening 460 to prevent plant material from moving out of the top of the housing 410. As shown in FIG. 8, the housing 410 can also include feet 413 coupled to the bottom surface 412 to support the system 400 (e.g., when unattached to the vehicle 490).

As shown in FIG. 4, each of the first wheel assembly 480A and the second wheel assembly 480B include a wheel and mounting components (e.g., elongated bars and/or brackets) coupling the wheel to the housing 410 (e.g., to each of the opposing sidewalls 414 of the housing 410). The first and second wheel assemblies 480A and 480B can each be mounted to the housing 410 such that the system 400 can be supported at least in part by the first and second wheel assemblies 480A and 480B and can be translated via rotation of the wheels of the first and second wheel assemblies 480A and 480B. As shown in FIG. 5, the system 400 (e.g., the housing 410) can also be mounted to or include the vehicle 490 such that the system 400 is partially supported by the first and second wheel assemblies 480A and 480B and is partially supported by and translatable via rotation of the wheels of the first and second wheel assemblies 480A and 480B under the power of the vehicle 490. The vehicle 490 can be any suitable vehicle configured to push the system 400 forward, such as a tractor (e.g., a loader that may be modified to receive and engage with the housing 410).

Each of the first set of cutting blades 420A, the second set of cutting blades 420B, and the third set of cutting blades 420C can be disposed near or adjacent to a bottom front portion of the housing 410 (e.g., near or adjacent to a front edge of the bottom wall 412 of the housing 410). Each set of cutting blades 420 can be operable to sever a plant at a cutting location (e.g., at a base of a stalk) into a first plant portion and a second plant portion as the system 400 is advanced (e.g., translated forward) relative to (i.e., towards) the plant. The first plant portion can include, for example, flowers, leaves, and at least a portion of a stalk of the plant. The second plant portion can include, for example, roots and any portion of the stalk of the plant disposed below the cutting location.

As shown in FIG. 7, for example, each of the first set of cutting blades 420A, the second set of cutting blades 420B, and the third set of cutting blades 420C can include a plurality of cutting blades rotatable about a central axis. In some embodiments, the sets of cutting blades 420 can be rotated such that the contact with plants is an upward motion. For example, from the angle shown in FIG. 7, the cutting blades 420 can be configured to be rotated in a clockwise cutting motion. The central axis of each of the first set of cutting blades 420A, the second set of cutting blades 420B, and the third set of cutting blades 420C can be coaxial with each central axis of the remaining sets of cutting blades. The cutting blades of each of the first set of cutting blades 420A, the second set of cutting blades 420B, and the third set of cutting blades 420C can be rotated to serially contact and cut the plant at the cutting location to sever the plant. In some embodiments, each of the first set of cutting blades 420A, the second set of cutting blades 420B, and the third set of cutting blades 420C can include one, two, three, four, five, or more cutting blades coupled to (e.g., affixed to) and extending from a central axle. Each of the first set of cutting blades 420A, the second set of cutting blades 420B, and the third set of cutting blades 420C can be coupled to (e.g., affixed to) and extend from a central rotatable bar 424 such that rotation of the central rotatable bar 424 causes simultaneous rotation of each cutting blade of each of the first set of cutting blades 420A, the second set of cutting blades 420B, and the third set of cutting blades 420C about a central axis of the central rotatable bar. The central rotatable bar 424 can include discrete axle portions to which the cutting blades are attached formed as a unitary structure with connecting portions. For example, in some embodiments, the central rotatable bar 424 (also referred to as a drive shaft) can have a square cross-section, and each of the blades can be coupled to a tubular member having a square cross-section that is configured to receive the central rotatable bar 424 such that the tubular member can slide along the central rotatable bar 424. When disposed in a desired location along the central rotatable bar 424, bearings on each side of the tubular member can be mounted to the central rotatable bar 424 such that the tubular member is secured in place. The desired location of the tubular member and cutting blades can depend on the distance between beds of the plants to be harvested. For example, if the plants are arranged in beds spaced 60″ apart, the tubular member can be disposed such that a center of the tubular member is 60″ from the center of an adjacent tubular member so that plants can be harvested from the two beds simultaneously. If the beds are 30″ apart, the tubular members can be disposed such that their centers are 30″ apart. Each of the cutting blades of the set of cutting blades associated with each tubular member can extend from the tubular member. For example, the set of cutting blades can include four cutting blades, with each coupled to (e.g., welded to) and extending from a different external surface of the tubular member having a square cross section. Each cutting blade can have a surface that is co-planar with a surface of the tubular member and extend beyond the surface such that a cutting edge of the cutting blade can be rotated into severing contact with a plant. Thus, each cutting blade can be disposed in a plane that is perpendicular to the plane in which adjacent cutting blades are disposed and parallel to the plane in which an oppositely-disposed cutting blade is disposed. In some embodiments, each cutting blade can be flat and have a sharpened edge.

As shown in FIG. 7, the central rotatable bar 424 to which the first set of cutting blades 420A, the second set of cutting blades 420B, and the third set of cutting blades 420C are coupled can be partially enclosed within a bar housing 425. The bar housing 425 can define openings within which the first set of cutting blades 420A, the second set of cutting blades 420B, and the third set of cutting blades 420C are disposed such that the cutting blades can extend through the openings in the bar housing 425 to cut plants and/or plants can be received within the openings and into contact with the first set of cutting blades 420A, the second set of cutting blades 420B, and the third set of cutting blades 420C.

Each of the first set of projections 430A, the second set of projections 430B, and the third set of projections 430C can be arranged adjacent to a respective one of the first set of cutting blades 420A, the second set of cutting blades 420B, and the third set of cutting blades 420C. For example, each of the first set of projections 430A, the second set of projections 430B, and the third set of projections 430C can include a first projection extending from a first side of a set of cutting blades (e.g., from a first end of an axle of a set of cutting blades 420A, 420B, or 420C or a location near a first end of a set of cutting blades 420A, 420B, or 420C) and a second projection extending from a second side of the set of cutting blades (e.g., from a second end of the axle of the set of cutting blades 120 or a location near a second end of the set of cutting blades 420A, 420B, or 420C). As shown in FIG. 7, for example, the second set of projections 430B includes a first projection 432A and a second projection 434A. The first projection 432A and the second projection 432A are disposed on opposite sides of the set of cutting blades 420B. Additionally, the housing 425 can include segments extending between adjacent sets of projections 430A, 430B, or 430C. As shown in FIG. 7, in some embodiments, instead of projections being arranged in sets, a projection can optionally extend from only one side of a set of cutting blades, as shown with respect to the first set of cutting blades 420A.

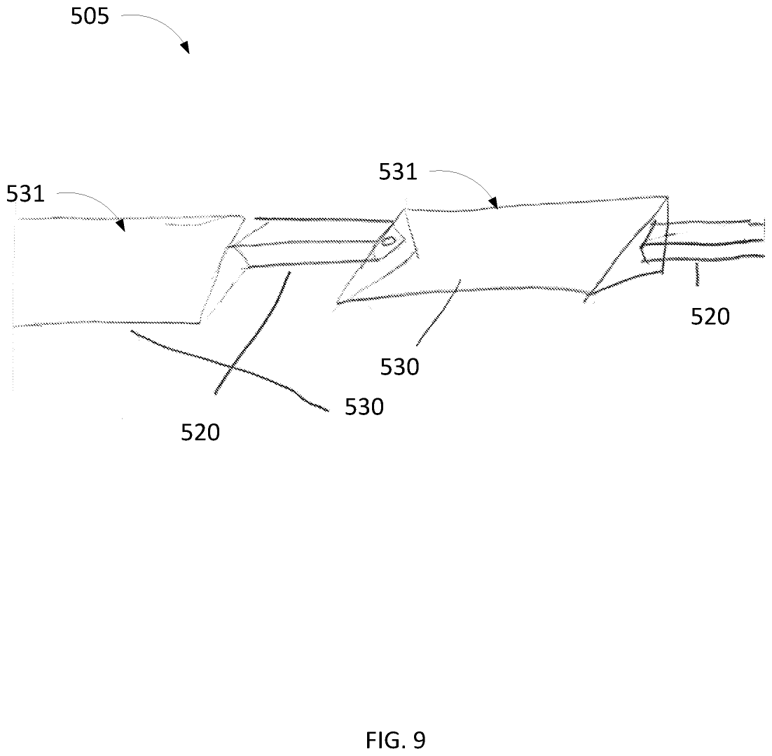

Each projection of the sets of projections 430A, 430B, and 430C can extend forward (i.e., distally) relative to the cutting blades of the respective sets of cutting blades 420A, 420B, and 420C such that the projections can contact a plant and lift portions of the first plant portion (e.g., leaves, stems, and/or branches) of the plant away from the cutting location of the stalk (e.g., upward) prior to the plant being received by the first set of cutting blades 420A, the second set of cutting blades 420B, or the third set of cutting blades 420C. For example, each projection of the sets of projections 430A, 430B, and 430C can be coupled (e.g., mounted) to the bar housing enclosing the central rotatable bar to which the sets of cutting blades 420A, 420B, and 420C are coupled. In some embodiments, as shown in FIG. 7, each projection of the sets of projections 430A, 430B, and 430C can taper away from the housing 410 and the respective sets of cutting blades 420A, 420B, and 420C. For example, each projection can taper from a larger height closer to a cutting blade to a lower height farther from the cutting blade. Each projection can have a maximum height that is higher than a distal-most portion of the nearest set of cutting blades such that any plant portion in contact with an upper surface of the projection will be urged away from a portion of the stalk of the plant first contacted by the set of cutting blades. In some embodiments, as shown in FIG. 7, the projections can each include a tapered extension member (e.g., extension member 435A) and a base portion (e.g., base portion 435B) on an end of the tapered extension member opposite the end coupled to the housing 410. The base portion can include flanges extending perpendicular to the extension member. In some embodiments, instead of including pairs of projections on either side of each cutting portion including a cutting blade set, the system 400 can include projections formed as tapered plates extending between the cutting portions as described with respect to other embodiments herein (e.g., projections 130, projections 530, FIG. 9). Such tapered plate projections can be formed to have any suitable feature described herein, such as having an upper surface that has a maximum height higher than a rotation axis or a maximum height of the cutting blade set in a cutting portion adjacent the tapered plate projection. Thus, in some embodiments, no portion of the cutting assembly 405 may include a distally facing flat surface, ensuring that plant portions are directed upward and into the interior space of the housing 410.

In some embodiments, each set of cutting blades 420A, 420B, and 420C can be disposed a distance from an adjacent set of cutting blades 420A, 420B, or 420C such that each set of cutting blades 420A, 420B, and 420C can be simultaneously aligned with a respective row of plants. The rows can be arranged in parallel relative to one another and a plant from each row can be simultaneously contacted and severed by a set of cutting blades 420A, 420B, and 420C aligned with that respective row. Although the system 400 is shown as including three sets of cutting blades, the system 400 can include any suitable number of cutting blades. For example, in some embodiments, the system 400 can include one, two, four, five, or more sets of cutting blades.

The tine assembly 440 includes five sets of tines. For example, the tine assembly can include a first set of tines 446A, a second set of tines 446B, a third set of tines 446C, a fourth set of tines 446D, and a fifth set of tines (not shown). In some embodiments, the tine assembly 440 can include more or fewer sets of tines (e.g., three sets, four sets, six sets). Each set of tines is configured to be rotated about a central axis of a drive shaft 442 to urge plant material (e.g., a first portion of a plant cut by the sets of cutting blades 420A, 420B, or 420C) into an interior of the housing 410 and toward the auger 450. Each set of tines can be coupled to and extend from a tine-supporting bar (also referred to as a “bat”). Specifically, the first set of tines 446A can extend from a first tine-supporting bar 444A, the second set of tines 446B can extend from a second tine-supporting bar 444B, the third set of tines 446C can extend from a fourth tine-supporting bar 444C, the fourth set of tines 446D can extend from a fourth tine-supporting bar 444D, and the fifth set of tines can extend from a fifth tine-supporting bar (now shown). Each set of tines can be arranged in a row extending from a first end to a second end of the tine-supporting bar to which the tines are couple. Each tine-supporting bar can be disposed parallel to the remaining tine-supporting bars.

Each tine-supporting bar 444A, 444B, 444C, and 444D can be coupled to and equidistant from the drive shaft 442 such that the tine-support bar rotates with and about the drive shaft 442. For example, the tine assembly 440 can include one or more plates 448A, 448B, 448C, and 448D and one or more extension portions 449 extending from each plate 448A, 448B, 448C, 448D. Each plate 448A, 448B, 448C, and 448D can be fixedly coupled to the drive shaft 442 at discrete locations along the drive shaft 442 (e.g., at a first end, a second end, and at intermediate locations along the drive shaft 442). Each tine-supporting bar 444A, 444B, 444C, and 444D can be fixedly coupled to each plate 448A, 448B, 448C, and 448D via extension portions 449 fixedly coupled to and extending away from each plate 448A, 448B, 448C, and 448D. In some embodiments, as shown in FIGS. 4-7, the extension portions 449 coupled to each plate 448A, 448B, 448C, and 448D can be disposed equidistant from one another about an outer perimeter of each plate 448A, 448B, 448C, and 448D. In some embodiments, each extension portion 449 can define an opening through which a portion of a tine-supporting bar 444A, 444B, 444C, and 444D can pass. In some embodiments, each tine-supporting bar 444A, 444B, 444C, and 444D can be formed by discrete sections coupled to one another via an extension portion 449. The tine assembly 440 can include any suitable number of plates 448A, 448B, 448C, and 448D to support the tine-supporting bars 444A, 444B, 444C, and 444D relative to the drive shaft 442. For example, as shown in FIGS. 4-7, the tine assembly 440 can include a first plate 448A, a second plate 448B, a third plate 448C, and a fourth plate 448D. Each plate 448A, 448B, 448C, and 448D can include a number of extension portions 449 equal to the number of tine-supporting bars 444A, 444B, 444C, and 444D and sets of tines of the tine assembly 440 (e.g., five). Each tine of each set of tines 446A, 446B, 446C, and 446D can extend from the respective tine-supporting bar 444A, 444B, 444C, and 444D at any suitable angle relative to a plane including the tine-supporting bar and the drive shaft 442. For example, the angle can be between about 90 degrees and 180 degrees, between about 95 degrees and 135 degrees, between about 95 degrees and 120 degrees, between about 90 degrees and 115 degrees, or between about 95 degrees and 115 degrees.

The tine assembly 440 can include a sweep bar associated with each set of tines. For example, a first sweep bar 445A can be coupled to each of the extensions portions 449 supporting the first tine-supporting bar 444A (e.g., to a first side or edge of each extension portion 449). A second sweep bar 445B can be coupled to each of the extensions portions 449 supporting the second tine-supporting bar 444B. A third sweep bar 445C can be coupled to each of the extensions portions 449 supporting the third tine-supporting bar 444C. A fourth sweep bar 445D can be coupled to each of the extensions portions 449 supporting the fourth tine-supporting bar 444D. A fifth sweep bar (not shown) can be coupled to each of the extensions portions 449 supporting the fifth tine-supporting bar.

In some embodiments, rather than the tine assembly 440 including a drive shaft 442, plates or other supporting elements of the tine assembly 440 can be directly rotated by the motor assembly 470 and can be configured to rotate the tine-supporting bars and sets of tines about a central axis. For example, the tine assembly 440 can define an open interior space between the tine-supporting bars 444A, 444B, 444C, 444D, and 444E.

The auger 450 can be used to urge plant material (e.g., a first portion of a plant cut by the sets of cutting blades 420A, 420B, or 420C) disposed within the interior of the housing 410 toward and through the rear opening 460 defined by the housing 410. As the plant portions exit the housing 410 via the rear opening 460 and the system 400 advances forward, the plant portions a row of plant portions behind the system 400. As shown in FIG. 8, in some embodiments, the rear opening 460 can be centered along the back and/or bottom of the housing 410.

As disclosed above, the motor assembly 470 can be operably coupled to each of the auger 450, the tine assembly 440, and the sets of cutting blades 420A, 420B, or 420C (e.g., via a pulley assembly). For example, the motor assembly 470 can be coupled to a central rotatable bar of the auger 450 (e.g., via a pulley and a wheel 472), the central rotatable bar of the tine assembly 440 (e.g., via a pulley and a wheel 474), and the central rotatable bar to which the sets of cutting blades 420A, 420B, or 420C are coupled (e.g., via a drive pulley 476A (not shown in FIG. 5) and a wheel 476) such that the motor assembly 470 can simultaneously rotate the auger 450, the tine assembly 440, and the cutting blades 420A, 420B, or 420C. The drive pulley 476A can be a larger (e.g., wider and/or thicker pulley than the pulleys associated with the auger 450 and the tine assembly 440 such that sufficient rotational force is applied to the central rotatable bar (also referred to as a drive shaft) to which the sets of cutting blades can be coupled. In some embodiments, the drive pulley 476A can be a 3V belt.

The motor assembly 470 can be, for example, a hydraulic motor and can be powered and controlled via the vehicle 490. For example, the system 400 can include hoses (e.g., hydraulic hoses) configured to couple the motor of the system 400 to a hydraulic actuator of the vehicle 490 such that an interface of the vehicle 490 can be used to control the actuation and direction of rotation of the auger 450, the tine assembly 440, and the cutting blades 420. In some embodiments, rather than including a hydraulic motor, for example, the system can be mechanically driven, such as via being coupled to a PTO shaft via a gear box.

As shown in FIG. 4, the housing 410 can also include or be coupled to a pair of bars 419 disposed on an opposite side of the pulley assembly from the sidewall 414 of the housing to which the pulley assembly is mounted. As shown, the bars 419 can be disposed parallel to each other and can extend from a region distal of the pulley assembly (e.g., a distal edge of the sidewall 414) to a region proximal of the pulley assembly (e.g., attached to the motor of the motor assembly 470). In some embodiments, the bars 419 can be disposed at different angles relative to the sidewall 414 and/or the ground. The bars 419 can be vertically spaced and, optionally, horizontally disposed when the system 400 is in an operating configuration (e.g., translating forward). The bars 419 can be positioned such that they block debris from traveling into the pulley assembly and contacting the pulleys (e.g., the pulleys associated with the auger 450 and the tine assembly 440. For example, the bars 419 can be positioned to block debris (e.g., rocks, dirt) that may be kicked up or otherwise displaced by the wheel 480A. Although not shown or described with respect to other embodiments herein, any of the embodiments described herein can include bars similar to the bars 419 to prevent debris from reaching the pulley assembly from below.

To operate the system 400, after coupling the motor assembly 470 to the hydraulic actuator of the vehicle 490 and mechanically engaging a rear portion of the housing 410 with the vehicle 490 such that the housing 410 is partially supported by the wheels 480A and 480B and partially supported by the vehicle 490, the vehicle 490 can be operated to advance the housing 410 toward one or more rows of plants (e.g., three rows of plants) that are spaced apart about the same distance as the one or more sets of cutting blades 420A, 420B, or 420C are spaced relative to an adjacent set of cutting blades. As the first set of cutting blades 420A, for example, nears a plant, the first set of projections 430A can first contact a first portion of the plant (e.g., leaves and/or branches of the plant). As the system 400 continues to advance relative to the plant, the first portion of the plant can be urged upward due to the taper (i.e., the increasing height relative to the ground) of the first set of projections 430A, exposing a cutting location of the plant. When the first set of cutting blades 420A contacts the plant at the cutting location and separates (e.g., slices) the plant into the first plant portion and a second plant portion (e.g., the root and base of the stalk below the cutting location), the first set of tines 446A can rotate downward to contact the first plant portion and urge the first plant portion into an interior of the housing 410 and toward the auger 450. When the first plant portion reaches the auger 450, the auger 450 can urge the first plant portion 450 toward the rear opening 460 such that the first plant portion 450 falls through the rear opening 460 into a row of first plant portions being formed behind the system 400. Each of the other sets of cutting blades 420B and 420C and sets of projections 430B and 430C, respectively, can simultaneously separate other plants into first and second plant portions such that the tine assembly 440 also pulls the other first plant portions into the interior of the housing 410 and toward the auger 450 simultaneously. Each of the sets of cutting blades 420A, 420B, and 420C, the tine assembly 440, and the auger 450 can simultaneously be operating on different first plant portions simultaneously as the system 400 advances down one, two, or three rows of plants to cut the plants and form them into a single row (e.g., a windrow).

As described above, in some embodiments, the systems described herein can include projections formed as tapered plates extending distally relative to cutting portions. For example, FIG. 9 is a schematic illustration of a portion of a cutting assembly 505 including cutting portion 520 each including at least one cutting blade and projections 530. The cutting assembly 505 can be used in any of the systems described herein and can include any of the features described herein. As shown, the projections 530 extend substantially the entirety of the distance between the adjacent cutting portions 520 and are tapered in the distal direction such that the upper surface 531 (e.g., the non-stalk plant portion contacting surface) of each projection is lower the farther from the cutting portions 520 the projections 530 extend. Since the cutting portions 520 can be arranged to align with planted rows of plants (e.g., hemp plants) as described herein, the length of the projections 530 between cutting portions 520 can be slightly less than the distance between plants in parallel adjacent rows of plants.

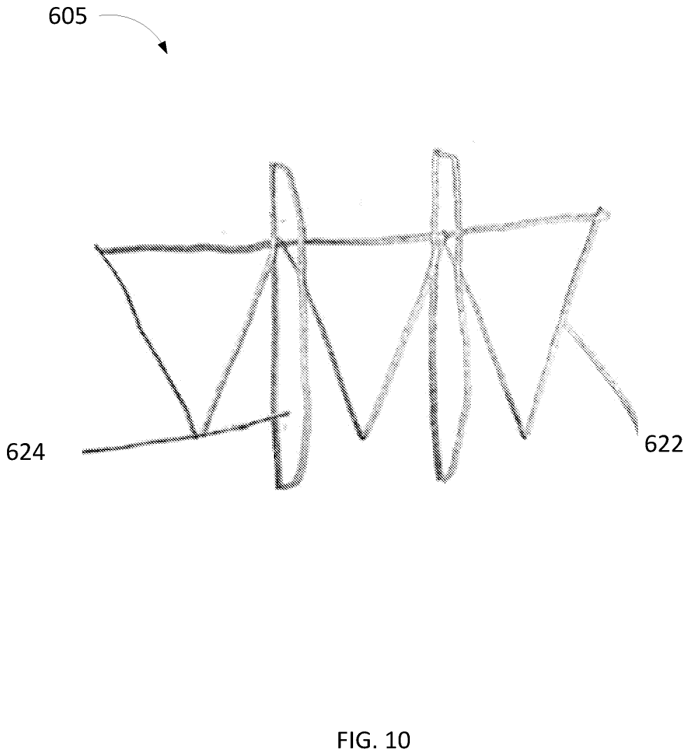

As described above, in some embodiments, the systems described herein can include a cutting assembly including cutting blades that have a lateral cutting motion (e.g., move back and forth in a scissoring action). For example, FIG. 10 is a schematic illustration of a portion of a cutting assembly 605 including a sickle bar-style cutting head that can be included in any of the cutting portions described herein (e.g., cutting portion 120). The sickle bar head is configured to move in a scissor-style cutting motion. As shown in FIG. 10, the cutting assembly 605 can include cutting blades 622 (also referred to as teeth or mowing fingers) arranged in series along a longitudinal axis and coupled directly to one another or to a shared bar (e.g., a cutter bar). The cutting assembly 605 can also include sickle guards 624 which can be disposed between each adjacent pair of blades 622 in an initial configuration before a cutting motion begins. The blades 622 can then be moved laterally along the longitudinal axis (perpendicular to the direction of movement of the system within which the cutting assembly 605 is included) back and forth relative to the sickle guards 624 to cut plants in a scissoring-style cutting motion. As shown, the cutting blades 622 can be shaped as triangular distally-extending teeth.

While various embodiments of the invention have been described above, it should be understood that they have been presented by way of example only, and not limitation. Where methods described above indicate certain events occurring in certain order, the ordering of certain events may be modified. Additionally, certain of the events may be performed concurrently in a parallel process when possible, as well as performed sequentially as described above.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

In addition, the disclosure may include other innovations not presently described. Applicant reserves all rights in such innovations, including the right to embodiment such innovations, file additional applications, continuations, continuations-in-part, divisional s, and/or the like thereof. As such, it should be understood that advantages, embodiments, examples, functional, features, logical, operational, organizational, structural, topological, and/or other aspects of the disclosure are not to be considered limitations on the disclosure as defined by the embodiments or limitations on equivalents to the embodiments. Depending on the particular desires and/or characteristics of an individual and/or enterprise user, database configuration and/or relational model, data type, data transmission and/or network framework, syntax structure, and/or the like, various embodiments of the technology disclosed herein may be implemented in a manner that enables a great deal of flexibility and customization as described herein.

All definitions, as defined and used herein, should be understood to control over dictionary definitions, definitions in documents incorporated by reference, and/or ordinary meanings of the defined terms.

As used herein, in particular embodiments, the terms “about” or “approximately” when preceding a numerical value indicates the value plus or minus a range of 10%. Where a range of values is provided, it is understood that each intervening value, to the tenth of the unit of the lower limit unless the context clearly dictates otherwise, between the upper and lower limit of that range and any other stated or intervening value in that stated range is encompassed within the disclosure. That the upper and lower limits of these smaller ranges can independently be included in the smaller ranges is also encompassed within the disclosure, subject to any specifically excluded limit in the stated range. Where the stated range includes one or both of the limits, ranges excluding either or both of those included limits are also included in the disclosure.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of” “only one of” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While specific embodiments of the present disclosure have been outlined above, many alternatives, modifications, and variations will be apparent to those skilled in the art. Accordingly, the embodiments set forth herein are intended to be illustrative, not limiting. Various changes may be made without departing from the spirit and scope of the disclosure. Where methods and steps described above indicate certain events occurring in a certain order, those of ordinary skill in the art having the benefit of this disclosure would recognize that the ordering of certain steps may be modified and such modification are in accordance with the variations of the invention. Additionally, certain of the steps may be performed concurrently in a parallel process when possible, as well as performed sequentially as described above. The embodiments have been particularly shown and described, but it will be understood that various changes in form and details may be made.

1. A system, comprising:
a housing defining an interior space and at least one rear opening;
a cutting assembly including a plurality of axially-aligned cutting portions and a plurality of projections extending distally relative to the plurality of cutting portions and configured to urge a non-stalk portion of a plant vertically upward relative to a stalk portion of the plant, each cutting portion separated from an adjacent cutting portion by at least one projection of the plurality of projections, adjacent projections of the plurality of projections extending distally from opposite sides of each cutting portion defining a receiving space aligned with each cutting portion within which the stalk of a plant can be received to contact the respective cutting portion and be cut by the cutting portion such that the plant is divided into a first plant portion and a second plant portion;
a tine assembly configured to be rotated to urge the first plant portion into the interior space of the housing; and
an auger disposed within the interior space and configured to urge the first plant portion toward and through the at least one rear opening.

2. The system of claim 1, wherein the housing defines a rear opening disposed proximally of and aligned with each cutting portion.

3. The system of claim 1, wherein the plurality of projections includes a pair of projections associated with each cutting portion of the plurality of cutting portions, each pair of projections including a first projection extending distally from a first side of a cutting portion and a second projection extending distally from a second side of the respective cutting portion.

4. The system of claim 1, wherein the plurality of projections includes a projection disposed between a first cutting portion of the plurality of cutting portions and a second cutting portion of the plurality of cutting portions, the projection defining both a boundary of a receiving space aligned with the first cutting portion and a boundary of a receiving space aligned with the second cutting portion.

5. The system of claim 1, wherein each projection of the plurality of projections includes an upper surface that is tapered downward such that more distal portions of the upper surface are vertically lower than more proximal portions of the upper surface.

6. The system of claim 1, wherein the cutting portions each include at least portions of cutting blades that are rotatable in a cutting motion about an axis common to all of the cutting portions.

7. The system of claim 1, wherein the cutting portions each include cutting blades that are laterally translatable in a cutting motion along an axis common to all of the cutting portions.

8. The system of claim 1, wherein the system is configured to be coupled to one or more wheel assemblies and to be translated distally such that each of the receiving spaces aligned with the cutting portions simultaneously receives a distinct plant from a set of plants, each cutting portion simultaneously cuts each distinct plant into a first plant portion and a second plant portion, the tine assembly urges the first plant portions into the interior space, the auger urges the first plant portions towards and through the at least one rear opening, and the first plant portions are deposited to form one or more windrows proximal of the system.

9. The system of claim 1, further comprising an actuation assembly operably coupled to the cutting assembly, the tine assembly, and the auger and configured to control operation of the cutting assembly, the tine assembly, and the auger such that the cutting assembly moves in a cutting motion, the tine assembly rotates, and the auger assembly rotates simultaneously.

10. The system of claim 1, wherein the cutting portions each include a tubular member and a set of cutting blades coupled to the tubular member, the cutting assembly including a central rotatable bar configured to be received through a central passageway of each tubular member, the tubular member of each cutting portion configured to be secured to a location on the central rotatable bar such that rotation of the central rotatable bar causes rotation of the cutting blades and such that the cutting blades contact the plant with an upwardly directed cutting motion.

11. The system of claim 1, wherein the housing defines three axially-aligned rear openings in communication with the interior space.

12. The system of claim 11, wherein each of the rear openings has a width less than the axially-spaced distance between center points of adjacent cutting portions.

13. A method, comprising:
advancing a housing such that a base of a stalk of a plant is received in a receiving space defined between a first projection and a second projection extending distally from a front of the housing and such that at least one of the first projection or the second projection urges a non-stalk portion of the plant vertically upward away from the base of the stalk; and
further advancing the housing such that cutting blades disposed between the first projection and the second projection sever the base of the stalk of the plant at a cutting location such that the plant is divided into a first plant portion and a second plant portion and the first plant portion is pulled into an interior space of the housing by a tine assembly disposed at least partially within the housing and urged toward a rear opening of the housing by an auger such that the first plant portion is deposited behind the housing via the rear opening as the housing is advanced.

14. The method of claim 13, wherein the plant is a first plant and the rear opening is a first rear opening, wherein advancing the housing includes advancing the housing such that a second plant is received in a receiving space defined between the second projection and a third projection, the third projection extending distally from the front of the housing, and such that at least one of the second projection and the third projection urges a non-stalk portion of the second plant vertically upward away from the base of the stalk of the second plant; and wherein further advancing the housing includes advancing the housing such that cutting blades disposed between the second projection and the third projection sever the base of the stalk of the second plant at a cutting location such that the second plant is divided into a first plant portion and a second plant portion and the first plant portion is pulled into an interior space of the housing by the tine assembly and urged toward a second rear opening of the housing by an auger such that first plant portion of the second plant is deposited behind the housing via the second rear opening as the housing is advanced.

15. The method of claim 13, wherein the plant is a first plant and the rear opening is a first rear opening, wherein advancing the housing includes advancing the housing such that a second plant is received in a receiving space defined between a third projection and a fourth projection, the third projection and the fourth projection each extending distally from the front of the housing, and such that at least one of the third projection and the fourth projection urges a non-stalk portion of the second plant vertically upward away from the base of the stalk of the second plant; and wherein further advancing the housing includes advancing the housing such that cutting blades disposed between the third projection and the fourth projection sever the base of the stalk of the second plant at a cutting location such that the second plant is divided into a first plant portion and a second plant portion and the first plant portion is pulled into an interior space of the housing by the tine assembly and urged toward a second rear opening of the housing by an auger such that first plant portion of the second plant is deposited behind the housing via the second rear opening as the housing is advanced.

16. A method, comprising:
receiving a base of a stalk of a plant into a receiving space defined between a first projection and a second projection such that at least one of the first projection or the second projection urges a non-stalk portion of the plant upward away from the base of the stalk to expose a cutting location on the base of the stalk;
severing the exposed base of the stalk into a first plant portion and a second plant portion at the cutting location using one or more cutting blades disposed proximally of the receiving space;
moving the first plant portion into an interior of the housing using a tine assembly disposed at least partially within the housing; and
urging the first plant portion toward a rear opening of the housing using an auger such that the first plant portion exits the housing via the rear opening.

17. The method of claim 16, wherein the plant is a first plant, the receiving space is a first receiving space, and the rear opening is a first rear opening; the receiving includes simultaneously receiving a base of a second plant into a second receiving space defined between the second projection and a third projection such that at least one of the second projection or the third projection urges a non-stalk portion of the second plant upward away from the base of the stalk to expose a cutting location on the base of the stalk of the second plant; the severing includes severing the exposed base of the stalk of the second plant into a first plant portion and a second plant portion at the cutting location using one or more cutting blades disposed proximally of the second receiving space; the moving includes moving the first plant portion of the second plant into an interior of the housing using the tine assembly; and the urging includes urging the first plant portion of the second plant toward a second rear opening of the housing using the auger such that the first plant portion of the second plant exits the housing via the second rear opening.

18. The method of claim 17, wherein the first rear opening is aligned with at least one of the first receiving space or the second receiving space, and the urging includes urging the first plant portion of the first plant toward the first rear opening of the housing using the auger such that the first plant portion of the first plant exits the housing via the first rear opening to form a portion of a windrow aligned with the first receiving space or the second receiving space.

19. The method of claim 16, wherein the plant is a first plant, the receiving space is a first receiving space, and the rear opening is a first rear opening; the receiving includes simultaneously receiving a base of a second plant into a second receiving space defined between a third projection and a fourth projection such that at least one of the third projection or the fourth projection urges a non-stalk portion of the second plant upward away from the base of the stalk to expose a cutting location on the base of the stalk of the second plant; the severing includes severing the exposed base of the stalk of the second plant into a first plant portion and a second plant portion at the cutting location using one or more cutting blades disposed proximally of the second receiving space; the moving includes moving the first plant portion of the second plant into an interior of the housing using the tine assembly; and the urging includes urging the first plant portion of the second plant toward a second rear opening of the housing using the auger such that the first plant portion of the second plant exits the housing via the second rear opening.

20. The method of claim 19, wherein the first rear opening is aligned with at least one of the first receiving space or the second receiving space, and the urging includes urging the first plant portion of the first plant toward the first rear opening of the housing using the auger such that the first plant portion of the first plant exits the housing via the first rear opening to form a portion of a windrow aligned with the first receiving space or the second receiving space.
